(19) United States
(12) Patent Application Publication
(10) Pub. No.: US 2004/0188198 A1
(43) Pub. Date: Sep. 30, 2004

(54) Brake apparatus using magnetic powder

(76) Inventor: Jong-Kap Na, Seoul (KR)

Correspondence Address: INTELLECTUAL PROPERTY GROUP, FREDRIKSON & BYRON, P.A., 200 SOUTH SIXTH STREET, SUITE 4000, MINNEAPOLIS, MN, 55402, US

(21) Appl. No.: 10/482,325

(22) PCT Filed: Dec. 30, 2002
(86) PCT No.: PCT/KR02/02498

(30) Foreign Application Priority Data
Dec. 31, 2001 (KR) 10-2001-0089347
Feb. 21, 2002 (KR) 10-2002-0009407
Apr. 12, 2002 (KR) 10-2002-0020179
Apr. 12, 2002 (KR) 10-2002-0020180
Apr. 17, 2002 (KR) 10-2002-0021069
Apr. 17, 2002 (KR) 10-2002-0021070
Apr. 17, 2002 (KR) 10-2002-0021071
Apr. 17, 2002 (KR) 10-2002-0021072
Dec. 2, 2002 (KR) 10-2002-0075928
Dec. 30, 2002 (KR) 10-2002-0086580

(51) Int. Cl. F16F 9/53

(52) U.S. Cl. 188/267.2

(57) ABSTRACT

Disclosed is a brake apparatus using magnetic powder which includes first and second brackets faced to each other, a ring-shaped stator installed between the first and second brackets and having a coil therein, a ring-shaped brake fixed spaced apart from an inner circumference of the stator, a rotary shaft rotatably combined to an axial hole formed at a center of the second bracket, a rotator rotatably installed to the rotary shaft with its outer circumference being spaced apart from an inner circumference of the brake, and magnetic powder filled in a space between the inner circumference of the brake and the outer circumference of the rotator.

### TECHNICAL FIELD

The present invention relates to a brake apparatus using magnetic powder, and more particularly to a brake apparatus using magnetic powder which may operate in accurate response to control electric current change by preparing a damper between a stator and a rotator so that the damper is stuck to the stator.

### BACKGROUND ART

Generally, a brake apparatus using magnetic powder is adopted for decelerating or stopping a rotating object on the center of a rotary shaft. The brake apparatus includes magnetic powder which is magnetized when a magnetic force is applied, so a frictional force between the magnetic powder and a rotator causes the deceleration or stopping of the object. An example of such a brake apparatus using magnetic powder is disclosed in Japanese Patent Laid-open Publication No. H7-293607, which is schematically shown in FIG. 1.

Referring to FIG. 1, the conventional brake apparatus using magnetic powder includes a coil 2 built in a ring-shaped stator 1 in a circumferential direction. The stator 1 is fixed and supported by a first bracket 3 and a fourth bracket 29 made of aluminum or cast iron and having a disk shape. A rotary shaft 8 is connected to the first bracket 3 and supported by bearings 9 and 10. A rotator 26 is faced with an inner circumference of the stator 1 and integrally stuck to the rotary shaft 8 through a fifth bracket 30 in a circumferential direction of the rotary shaft 8. A protection plate 28 is attached to one side of the rotator 26 so that magnetic powder 12 is sealed in a minute space between the inner circumference of the rotator 26 and the outer circumference of a damper 27. At this time, support plates 19, 20, 21 and 22 are used so that the sealed magnetic powder does not escape out of an operating unit. A temperature switch 25 is mounted on the outer circumference of the stator 1 in order to detect a frictional heat transferred from the operating unit. A motor drive fan 23 is mounted to an outer side of the fourth bracket 29 in which a plurality of air holes are perforated. Here, the stator 1, the rotator 26 and the damper 27 are made of mild steel material of carbon steel having magnetism, which is useful for efficiently generating magnetic flux 6 when the coil 2 is excited.

The conventional brake apparatus using magnetic powder constructed as above is operated as follows. If an electric current flows through the coil 2 built in the stator 1, the coil 2 is excited to generate magnetic flux 6. Then, the magnetic powder 12 is chained in the minute space between the inner circumference of the rotator 26 and the outer circumference of the damper 27. The strength of the chain connection is changed depending on the intensity of the electricity. The strength change of the chain connection also changes the braking state of the rotator 26 which rotates together with the rotary shaft 8 so that the rotator 26 keeps rotating or is completely braked to stop its rotation. If the electricity is blocked, the magnetic flux is eliminated and the chain connection of the magnetic powder is released so that the rotator 26 may rotate freely without braking.

Thus, if the rotator 26 rotates with the magnetic powder 12 being chained, there is caused a friction between the magnetic powder 12 and the inner circumference of the rotator 26 together with the outer circumference of the damper 27, thereby generating a frictional heat. If this frictional heat increases above any criterion, the magnetic powder 12 is oxidized and sintered, thereby deteriorating the performance of the brake apparatus. In addition, since the frictional heat is transferred to the stator 1 to burn the coil 2, the magnetic flux 6 does not generate so that the brake apparatus loses its ability. In order to solve such problems, there is proposed a technique in which the fan 23 is mounted to the outer side of the fourth bracket 29 in order to forcibly blow external air for rapidly emitting the frictional heat transferred to the fourth bracket 29 and the protection plate 28, thereby improving the performance of the brake apparatus and extending its life. However, in such a technique, if the fan 23 stops due to a certain reason or the emission of the friction heat is delayed due to alien materials obstructed in the air holes, the brake apparatus is apt to be damaged by overheat and lose its ability. In that reason, the temperature switch 25 is installed on the outer circumference of the stator 1 so as to block the current flowing through the coil 2 when the temperature on the outer circumference of the stator 1 reaches a certain criterion for the purpose of preventing the damage of the brake apparatus.

As described above, the conventional brake apparatus using magnetic powder is configured that the rotator 26 is positioned between the inner circumference of the stator 1 and the outer circumference of the damper 27 rotates while the stator 1, the rotator 26 and the damper 27 are concentric. In addition, the conventional brake apparatus using magnetic powder is provided with the minute space having a gap of about 0.2 mm˜0.6 mm between the inner circumference of the stator 1 and the outer circumference of the rotator 26 for the purpose of successive and efficient magnetization. Thus, if applying the braking force or rotating the rotator with the concentricity being swerved due to the processing error, the concentricity of the stator, the rotator and the damper is more deviated, thereby making the rotational force irregular though a regular current is flowed. Even more, it makes the inner circumference of the stator be contacted with the outer circumference of the rotator in a more serious case, so the brake apparatus may lose its ability. In addition, there may happen a case that the temperature switch 25 malfunctions due to the lack of uniformity between the heat capacity of the frictional heat transferred from the rotator 26 to the temperature switch 25 installed to the outer side of the stator 11 and its transferring rate. Moreover, the temperature switch 25 installed on the outer circumference of the stator 1 may not detect an accurate frictional heat rapidly since it is spaced apart from the inner circumference of the rotator 26 and the outer circumference of the damper 27, which generate the frictional heat.

### DISCLOSURE OF INVENTION

The present invention is designed to solve the above problems, and therefore an object of the invention is to provide a brake apparatus, which is capable of preventing performance deterioration of magnetic powder and a damage of a coil due to overheat by accurately and rapidly detecting a frictional heat generated in an operating unit. In addition, an object of the invention is to provide a brake apparatus, which may improve ability and extend lift cycle by rapidly transferring and emitting the frictional heat generated in the operating unit so that the oxidization and sintering of the magnetic powder are restrained.

Another object of the present invention is to provide a brake apparatus using magnetic powder which may keep a space between an inner circumference of a stator and an outer circumference of a damper uniformly with the stator and the damper being fixed so that the braking force may be exactly controlled without deviation depending on the intensity of electricity and the stator and the damper may be operated concentrically.

In order to accomplish the above object, the present invention provides a brake apparatus using magnetic powder, which includes a ring-shaped stator fixed to a first bracket at one end and having a coil therein; a ring-shaped damper supported by the first bracket at one end and having an outer circumference spaced apart a predetermined distance from an inner circumference of the stator; a rotary shaft rotatably combined in an axial hole formed on the center of the first bracket; a rotator combined to the rotary shaft to rotate together and having an outer circumference spaced from an inner circumference of the damper; and magnetic powder filled in a space surrounded between the inner circumference of the damper and the outer circumference of the rotator.

According to another aspect of the invention, there is provided a brake apparatus using magnetic powder, which includes first and second brackets installed to be faced; a ring-shaped stator fixed between the first and second brackets and having a coil therein; a ring-shaped damper fixed spaced apart from an inner circumference of the stator on a concentric circumference between the first and second brackets; a rotary shaft rotatably combined in an axial hole formed on the center of the second bracket; a stator combined to the rotary shaft to rotate together on a concentric circumference between the first and second brackets and having an outer circumference spaced from an inner circumference of the damper; and magnetic powder filled in a space between the inner circumference of the damper and the outer circumference of the rotator.

Preferably, the brake apparatus using magnetic powder further includes a circular heat sink plate connected to the rotator to rotate together; and a plurality of blades protruded on the heat sink plate along a circumferential direction.

More preferably, the brake apparatus using magnetic powder further includes a third bracket extended to surround the stator together with the second bracket and supporting the damper.

Here, the second and third brackets may be made of aluminum.

According to another embodiment of the invention, the brake apparatus using magnetic powder further includes a heat conductive member interposed between the heat sink plate and the rotator for interconnection and having a higher heat conductivity than the rotator for transferring heat to the heat sink plate.

Preferably, the brake apparatus using magnetic powder further includes a temperature switch installed in contact with a side of the damper or with a bracket for supporting the side of the damper in order to detect a frictional heat generated during the operation of the brake apparatus.

According to another embodiment of the invention, the brake apparatus using magnetic powder further includes a middle connecting member made of nonmagnetic materials and installed at a meddle portion of the damper to divide the damper into two parts so that a magnetic force is focused.

Preferably, air passages are formed through the rotator so that air flows therethrough to improve the cooling effect.

In addition, the rotary shaft may be extended to pass through the rotator, and an end of the rotary shaft is rotatably supported by a bearing.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a sectional view showing an example of a brake apparatus using magnetic powder according to the prior art;

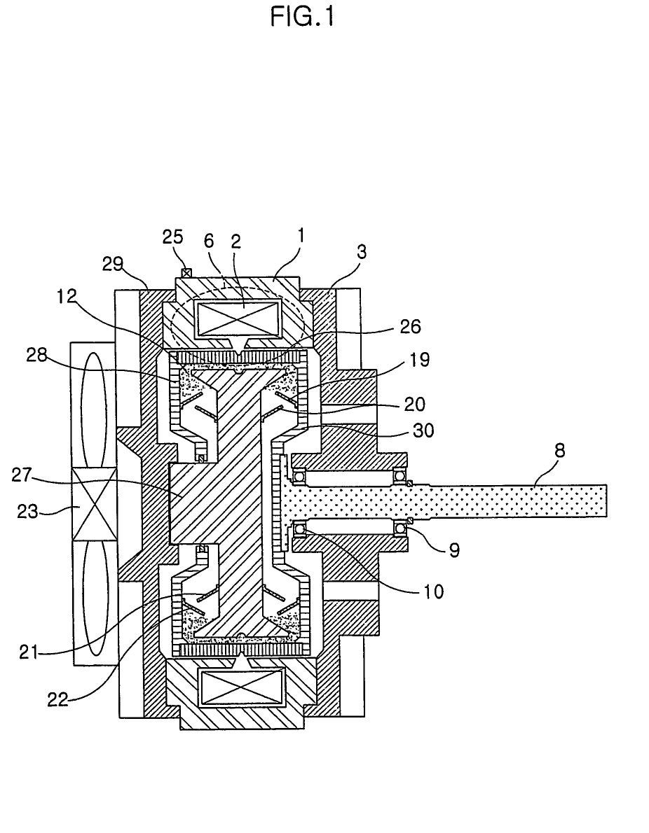

FIG. 2 is a sectional view showing a brake apparatus using magnetic powder according to a preferred embodiment of the present invention;

FIG. 3 is a sectional view showing a brake apparatus using magnetic powder according to another embodiment of the present invention;

FIG. 4 is a sectional view showing a brake apparatus using magnetic powder according to still another embodiment of the present invention;

FIG. 5 is a sectional view showing a brake apparatus using magnetic powder according to further another embodiment of the present invention;

FIG. 6 is a sectional view showing a brake apparatus using magnetic powder according to still further another embodiment of the present invention; and

FIG. 7 is a sectional view showing a brake apparatus using magnetic powder according to still further another embodiment of the present invention.

### BEST MODES FOR CARRYING OUT THE INVENTION

Hereinafter, preferred embodiments of the present invention will be described in detail with reference to the accompanying drawings.

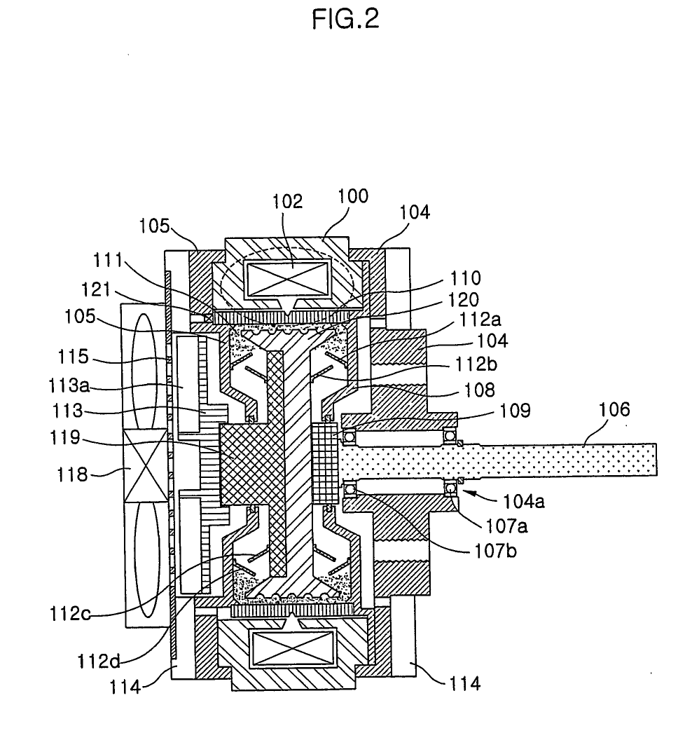

FIG. 2 shows a brake apparatus using magnetic powder according to a preferred embodiment of the present invention. Referring to FIG. 2, the brake apparatus using magnetic powder according to this embodiment includes a ring-shaped stator 100 having a coil 102 therein. The stator 100 is fixed between first and second brackets 104 and 105 which are faced to each other to configure a body of the brake apparatus. An axial hole 104a is formed on the center of the first bracket 104, and a rotary shaft 106 is rotatably combined in the axial hole 104a by means of bearings 107a and 107b.

According to the present invention, between the first and second brackets 104 and 105, a ring-shaped damper 110 is fixed in the stator 100 to be spaced apart a predetermined distance from the stator 100. Preferably, the damper 100 is supported and fixed by the second bracket 105 and a third bracket 108 extended from the first bracket 104 so that its outer circumference is faced with an inner circumference of the stator 100. Here, the second and third brackets 105 and 108 is made of nonmagnetic materials, preferably aluminum having excellent heat conductivity and corrosion resistance, and light and easy for shaping.

In addition, a rotator 120 is installed in the damper 110 so as to rotate with being spaced apart a predetermined distance from the damper 110. The rotator 120 is fixed to the rotary shaft 106 rotatably combined to the first bracket 104 so that it rotates together with the rotary shaft 106. Preferably, the rotator 120 may be combined to the rotary shaft through a separate connection member 109. More preferably, the connection member 109 is made of nonmagnetic materials so that a magnetic flux is focused between the stator 100 and the rotator 120 during the operation of the brake apparatus.

According to the present invention, the stator 100, the damper 110 and the rotator 120 are concentrically installed and preferably made of mild steel material among carbon steel having magnetism.

The second and third brackets 105 and 108 are extended to surround the rotator 120. In addition, in the second and third brackets 105 and 108, magnetic powder 111 is filled in a space between the damper 110 and the rotator 120. The magnetic powder 111 is not leaked or escaped out by means of support plates 112a, 112b, 112c and 112d respectively formed on the inner circumferences of the second and third brackets 105 and 108 and on the rotator 120.

According to the brake apparatus of the present invention described as above, since the damper 110 is fixed together with the stator 100, the minute space between the inner circumference of the stator 100 and the outer circumference of the damper 110 may be kept uniformly.

Furthermore, in the present invention, a heat sink plate 113 is provided to the rotator 120 so as to rotate together. Thus, the heat generated during the operation of the brake apparatus may be effectively cooled. Preferably, the heat sink plate 113 is a circular plate fixed to a side of the rotator 120 positioned opposite to the rotary shaft 106. In addition, the circular heat sink plate 113 has a plurality of blades 113a formed on its surface in a circumferential direction in order to promote the airflow. As mentioned above, the heat sink plate 113 is also made of materials having excellent heat conductivity (i.e., aluminum).

There are formed radiation pins 114 on the outer side of the second bracket 105 to enlarge an area contacted with the air so that the heat generated inside may be emitted rapidly. There is also provided a cover 115 out of the heat sink plate 113, and the cover 115 has a plurality of air passages therein. In addition, a fan 118 is further installed to an outer side of the second bracket 105 to which the heat sink plate 113 is provided. The fan 113 plays a role of forcibly blowing an external air into the brake apparatus.

According to another example of the present invention, a heat conductive member 119 made of materials having better heat conductivity than the rotator 120 (e.g., aluminum) is interposed between the rotator 120 and the heat sink plate 113 so that the heat generated due to the friction between the rotator 120 and the magnetic powder 111 is rapidly transferred to the heat sink plate 113.

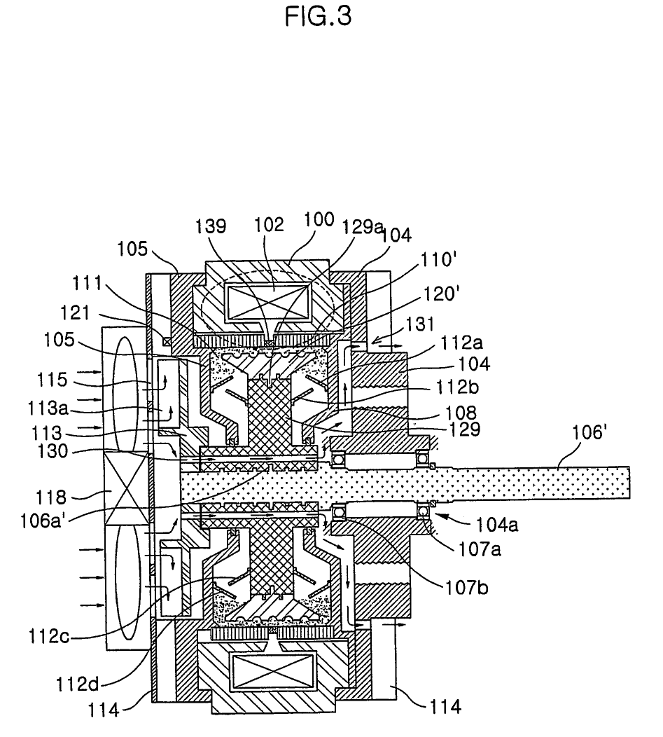

According to a more preferred embodiment of the present invention, a temperature switch 121 for detecting the temperature generated in the brake apparatus and outputting its control signal is installed in contact with a side of the damper 110 as shown in FIG. 2, or in contact with a side portion of the damper 110 as shown in FIG. 3. Thus, the heat generated in the operating unit of the brake apparatus can be detected immediately. The configuration of the temperature switch 121 is well known in the art, and not described in detail.

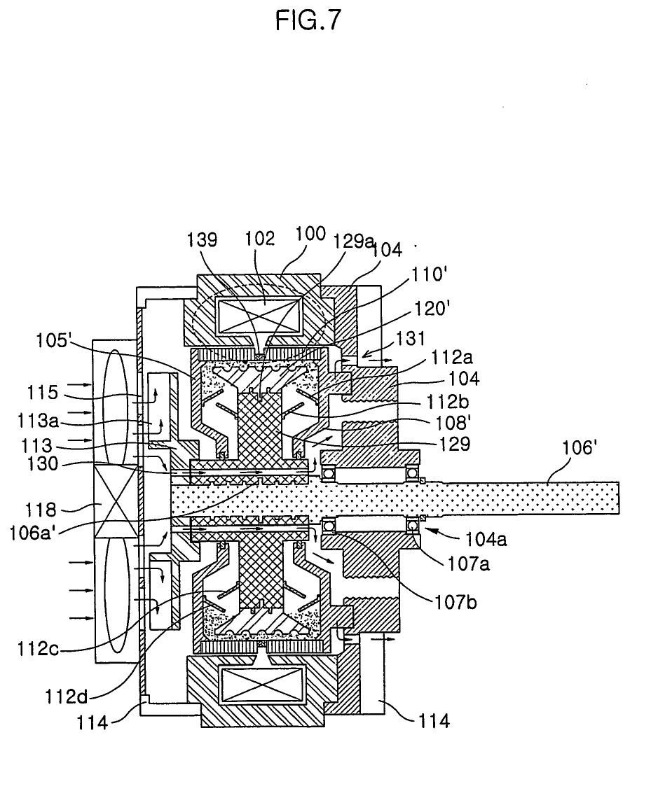

Though the stator and the damper are described in detail with reference to the drawings, their configurations are not limited to that case. For example, as shown in FIG. 7, the stator 100 may fixed to the first bracket 104 only at its one end, and the other end of the stator 100 may be directly fixed to the body case. In addition, the damper 110′ may be combined and supported to the first bracket 104 directly or indirectly through any other member. Specifically, it is possible that a protruded combination portion of the third bracket 108′ is inserted to a combination hole of the first bracket 104 and combined using a combination unit such as a screw. One end of the damper 110′ is combined to the third bracket 108′ configured as above, and the second bracket 105′ is extended downward on the other end of the damper 110′. Such configuration is useful for preventing the heat generated near the damper from transferring near the stator by spatially separating the damper from the stator. As an alternative, as described above, it is also possible to directly fix only one end of the damper 110′ to the first bracket 104. In other words, it should be understood that the structure of the bracket may be modified in any way if it enables to keep the space between the inner circumference of the stator and the outer circumference of the damper uniformly while the stator is fixed to the damper and if the technical concept of the present invention can be realized.

Now, the operation of the brake apparatus using magnetic powder according to a preferred embodiment of the present invention constructed as above is described.

If the current is applied to the coil 102 in order to decelerate or stop the rotation of the rotary shaft 106, the magnetic powder 111 between the damper 110 and the rotator 120 becomes chained due to the magnetic flux generated by excitation of the coil 102. At this time, the frictional force generated between the rotator 120 and the magnetic powder 111 makes the rotator 120 and the rotary shaft 106 be decelerated or stopped. Preferably, since the support members such as the first and second brackets 104 and 105 are made of nonmagnetic materials, the magnetic flux may be focused between the damper 110 and the rotator 120 as shown by the dotted line in the figures.

In the operation of the brake apparatus according to the present invention, since the damper 120 is fixed to the stator 100, the space between the damper 120 and the stator 100 may be kept accurately, for example as much as about 0.2 mm˜0.6 mm. Thus, the brake apparatus may show exact braking force in correspondence to the control current applied to the coil 102.

The heat generated during the braking process is transferred to the first and second brackets 104 and 105 and emitted out through the radiation pins 114 connected thereto. At the same time, the heat is rapidly transferred to the heat sink plate 113 combined to the rotator 120, and the heat sink plate 113 radiates the heat through the blades 113a in contact with the air blown by the fan 118 since the heat sink plate 113 rotates together with the rotator 120. At this time, if the heat conductive member 119 is provided between the rotator 120 and the heat sink plate 113, the heat transfer from the rotator 120 to the heat sink plate 113 is further promoted. Since the blades 113a of the heat sink plate 113 play the same role as a cooling fan by themselves, the cooling efficiency is resultantly more increased.

Furthermore, in the present embodiment, since the temperature switch 121 for detecting the heat generated in the operating unit of the brake apparatus is positioned near the side of the damper 110, the frictional heat generated between the damper 110 and the rotator 120 may be rapidly detected through the damper.

FIG. 3 shows a bake apparatus according to another embodiment of the present invention. Here, the same reference numeral as the former figure denotes the same component.

Referring to FIG. 3, the rotator 120′ of this embodiment is fixed to the rotary shaft 106′ rotatably supported by the first bracket 104 through the heat conductive member 129. The heat conductive member 129 is made of, for example, aluminum having excellent heat conductivity and shaping property. For the purpose of firm combination of the rotator 120′ to the rotary shaft 106′, uneven portions 129a and 106a may be formed on the rotator 120′ and the rotary shaft 106′ respectively. The rotator 120′ may be fit into the heat conductive member 129, or as an alternative they may be integrally formed by molding. The heat sink plate 113 is also extended to the heat conductive member 129 as described in the former embodiment.

According to another feature of the present invention, the damper 110′ may be divided into two parts by interposing a middle connection member 139 made of nonmagnetic materials at a middle portion of the damper 110′, as shown in FIG. 3, so that the two parts may keep a regular space between them. Such configuration is useful for concentrating the magnetic flux on the center portion between the rotator 120′ and the damper 110′ when the current is applied to the coil 102 to form the magnetic flux.

According to a more preferred feature of the present invention, a plurality of air passages 130 are formed through the rotator 120′ for interconnecting the space where the fan 118 is installed with the space where the rotary shaft 106′ is provided. More preferably, the air passages 130 are formed to pass through the heat conductive member 129 which interconnects the rotator 120′ and the rotary shaft 106′. In the operation of the brake apparatus using magnetic powder according to this embodiment, the external air flowed in by the fan 118 when the heat sink plate 113′ rotates according to the rotation of the rotary shaft 106′ is spread to all directions by means of the blades 113a of the heat sink plate 113′ as shown by arrows in the figure, and at the same time passing through the air passages 130 and discharged through a discharging hole 131 formed in the first bracket 104. According to such airflow, the frictional heat generated in the operating unit of the brake apparatus may be more rapidly emitted outside.

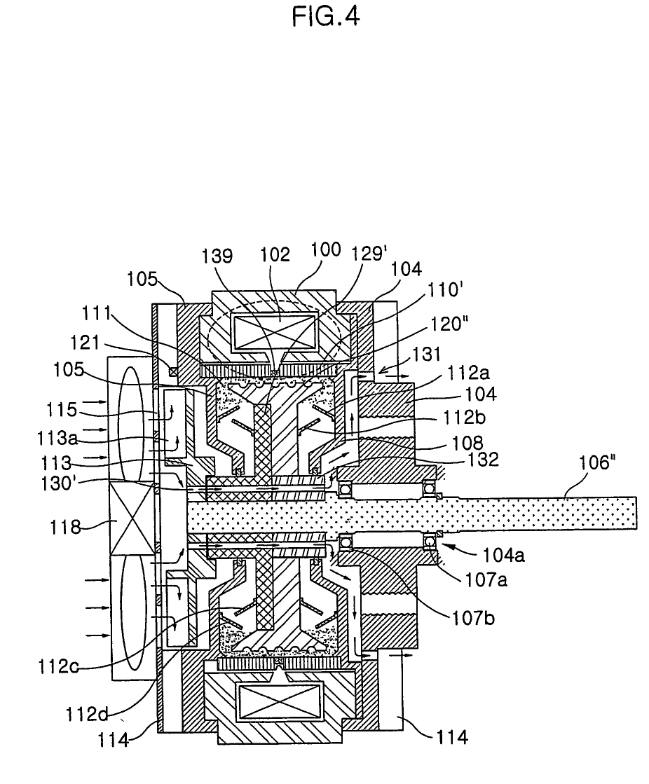

According to another aspect of the present invention, the heat conductive member interposed between the rotator and the rotary shaft may be adopted partially, as well shown in FIG. 4. Here, the same reference numeral as the former drawings denotes the same component having the same function.

As shown in FIG. 4, between the rotator 120″ and the rotary shaft 106″, a heat conductive member 129′ for partially connecting them is interposed. The heat conductive member 129′ is connected to the heat sink plate 113 so as to rapidly transfer the frictional heat generated in the space between the rotator and the damper to the heat sink plate 113, as mentioned above. The heat conductive member 129 is also made of materials having excellent heat conductivity such as aluminum, identical to the former embodiments. The reference numeral 132 denotes a subsidiary combination member for fixing the rotator 120″ to the rotary shaft 106″.

The heat conductive member 120′ and the subsidiary combination member 132 may be fit into or integrally combined by molding to the rotary shaft 106″. In addition, the air passages 130′ are formed to communicate the space where the fan 118 is positioned with the external space where the first bracket 104 is positioned. These air passages are identical to the former ones.

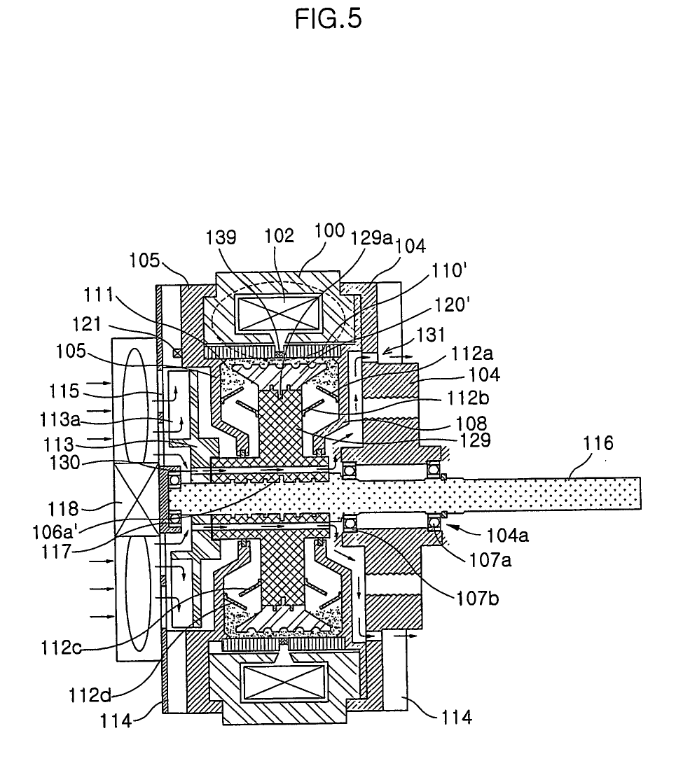

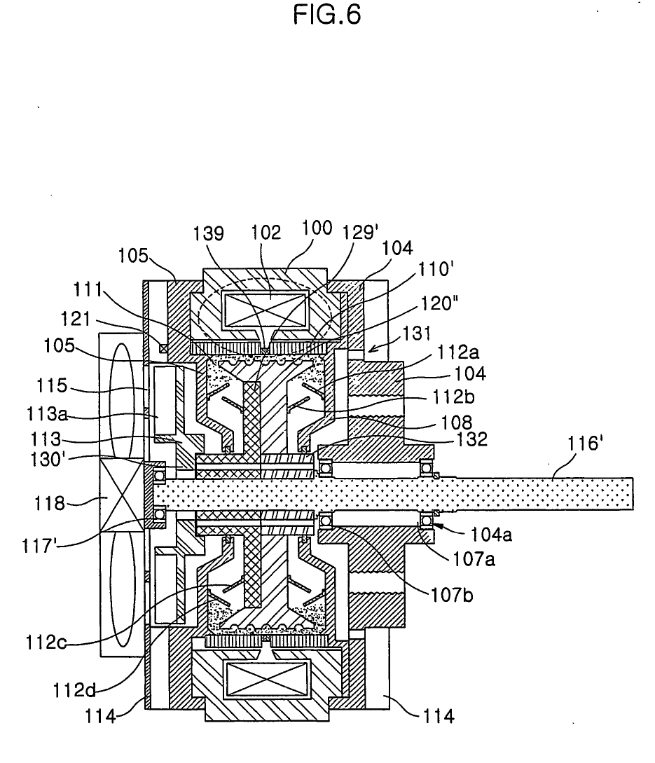

According to another embodiment of the present invention, the first bracket may be connected to the second bracket at two points for stable rotation, as well shown in FIGS. 5 and 6 respectively. The reference numerals in the figures not described below are identical to the former ones.

In other words, referring to FIGS. 5 and 6, an end of the rotary shaft 116 or 116′ passes through the rotator 120′ or 120″ and is then rotatably supported by a bearing 117 or 117′. The end of the rotary shaft 116 or 116′ is preferably supported to the cover 115, or as an alternative the end of the rotary shaft 116 or 116′ may be supported by a case configuring the brake apparatus.

According to this configuration, the rotary shaft 116 or 116′ may rotate smoothly since its one end is supported to the bearing 117 or 117′. In addition, the rotary shaft 116 or 116′ rotating smoothly makes the rotator 120′ or 120″ to be rotated with keeping its concentricity, thereby better ensuring the operational reliability of the brake apparatus.

### Industrial Applicability

According to the brake apparatus using magnetic powder of the present invention, the minute space between the stator and the damper may be kept uniformly since the damper is fixed between the stator and the rotator. Thus, though the rotator rotates with a strong braking force being exerted, the magnetic flux corresponding to the control current applied to the coil is exactly transferred to the damper, thereby giving uniform braking force. In addition, compared with the prior art in that the concentricity is swerved along with the rotation of the rotator to influence on the magnetization of the damper, the damper of the present invention may obtain uniform magnetization characteristics regardless of the rotator.

In addition, the present invention may cool the frictional heat generated in the operating unit more effectively since the heat sink plate and the blades are attached to the rotator for acting as a cooling fan. Such cooling effect may be further promoted by adopting the heat conductive member between the rotator and the heat sink plate, as well understood from the various embodiments of the present invention. Furthermore, the frictional heat may also be emitted out more rapidly by forming the air passages communicating from the area where the fan is positioned to the area where the rotary shaft is positioned and then flowing the air through the air passages.

Moreover, by installing the temperature switch in contact with the damper or on the side of the damper so as to immediately detect the frictional heat generated in the operating unit of the brake apparatus, the present invention may detect an excessive frictional heat rapidly and accurately when required and control the apparatus.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A brake apparatus using magnetic powder comprising:
a ring-shaped stator fixed to a first bracket at one end and having a coil therein;
a ring-shaped damper supported by the first bracket at one end and having an outer circumference spaced apart a predetermined distance from an inner circumference of the stator;
a rotary shaft rotatably combined in an axial hole formed on the center of the first bracket;
a rotator combined to the rotary shaft to rotate together and having an outer circumference spaced from an inner circumference of the damper; and
magnetic powder filled in a space surrounded between the inner circumference of the damper and the outer circumference of the rotator.

2. A brake apparatus using magnetic powder according to claim 1, wherein one end of the damper is directly fixed to the first bracket.

3. A brake apparatus using magnetic powder according to claim 1, wherein one end of the damper is fixed to the first bracket through another bracket which is formed downward to surround the rotator.

4. A brake apparatus using magnetic powder according to claim 1, further comprising:
a circular heat sink plate connected to the rotator to rotate together; and
a plurality of blades protruded on the heat sink plate along a circumferential direction.

5. A brake apparatus using magnetic powder according to claim 4, further comprising a heat conductive member interposed between the heat sink plate and the rotator for interconnection and having a higher heat conductivity than the rotator for transferring heat to the heat sink plate.

6. A brake apparatus using magnetic powder according to claim 5, wherein the stator is combined to the rotary shaft through the heat conductive member and a subsidiary combining member.

7. A brake apparatus using magnetic powder according to claim 6, wherein air passages are formed through the heat conductive member and the subsidiary combining member so that air flows therethrough.

8. A brake apparatus using magnetic powder comprising:
first and second brackets installed to be faced;
a ring-shaped stator fixed between the first and second brackets and having a coil therein;
a ring-shaped damper fixed spaced apart from an inner circumference of the stator on a concentric circumference between the first and second brackets;
a rotary shaft rotatably combined in an axial hole formed on the center of the second bracket;
a stator combined to the rotary shaft to rotate together on a concentric circumference between the first and second brackets and having an outer circumference spaced from an inner circumference of the damper; and
magnetic powder filled in a space between the inner circumference of the damper and the outer circumference of the rotator.

9. A brake apparatus using magnetic powder according to claim 8, further comprising:
a circular heat sink plate connected to the rotator to rotate together; and
a plurality of blades protruded on the heat sink plate along a circumferential direction.

10. A brake apparatus using magnetic powder according to claim 8, further comprising a third bracket extended to surround the stator together with the second bracket and supporting the damper.

11. A brake apparatus using magnetic powder according to claim 9, further comprising a heat conductive member interposed between the heat sink plate and the rotator for interconnection and having a higher heat conductivity than the rotator for transferring heat to the heat sink plate.

12. A brake apparatus using magnetic powder according to claim 11, wherein the rotator is combined to the rotary shaft through the heat conductive member.

13. A brake apparatus using magnetic powder according to claim 12, wherein air passages are formed through the heat conductive member so that air flows therethrough.

14. A brake apparatus using magnetic powder according to claim 11, wherein the rotator is combined to the rotary shaft through the heat conductive member and a subsidiary combining member.

15. A brake apparatus using magnetic powder according to claim 14, wherein air passages are formed through the heat conductive member and the subsidiary combining member so that air flows therethrough.

16. A brake apparatus using magnetic powder according to claim 8, further comprising a temperature switch installed in contact with a side of the damper or with a bracket for supporting the side of the damper in order to detect a frictional heat generated during the operation of the brake apparatus.

17. A brake apparatus using magnetic powder according to claim 8, further comprising a middle connecting member made of nonmagnetic materials and installed at a meddle portion of the damper to divide the damper into two parts so that a magnetic force is focused.

18. A brake apparatus using magnetic powder according to claim 8, wherein air passages are formed through the rotator so that air flows therethrough.

19. A brake apparatus using magnetic powder according to claim 18, wherein the air flowed in through the air passages is discharged through a discharge hole formed in the first bracket when the rotator rotates.

20. A brake apparatus using magnetic powder according to claim 8, wherein the rotary shaft is extended to pass through the rotator, and an end of the rotary shaft is rotatably supported by a bearing.

21. A brake apparatus using magnetic powder according to any of claim 8, wherein a cover in which a plurality of air holes are formed is provided out of the second bracket, and wherein a fan for forcibly blowing air is installed at a side of the cover.

22. A brake apparatus using magnetic powder according to claim 9, wherein a cover in which a plurality of air holes are formed is provided out of the second bracket, and wherein a fan for forcibly blowing air is installed at a side of the cover.

23. A brake apparatus using magnetic powder according to claim 10, wherein a cover in which a plurality of air holes are formed is provided out of the second bracket, and wherein a fan for forcibly blowing air is installed at a side of the cover.

24. A brake apparatus using magnetic powder according to claim 11, wherein a cover in which a plurality of air holes are formed is provided out of the second bracket, and wherein a fan for forcibly blowing air is installed at a side of the cover.

25. A brake apparatus using magnetic powder according to claim 12, wherein a cover in which a plurality of air holes are formed is provided out of the second bracket, and wherein a fan for forcibly blowing air is installed at a side of the cover.

26. A brake apparatus using magnetic powder according to claim 13, wherein a cover in which a plurality of air holes are formed is provided out of the second bracket, and wherein a fan for forcibly blowing air is installed at a side of the cover.

27. A brake apparatus using magnetic powder according to claim 14, wherein a cover in which a plurality of air holes are formed is provided out of the second bracket, and wherein a fan for forcibly blowing air is installed at a side of the cover.

28. A brake apparatus using magnetic powder according to claim 15, wherein a cover in which a plurality of air holes are formed is provided out of the second bracket, and wherein a fan for forcibly blowing air is installed at a side of the cover.

29. A brake apparatus using magnetic powder according to claim 16, wherein a cover in which a plurality of air holes are formed is provided out of the second bracket, and wherein a fan for forcibly blowing air is installed at a side of the cover.

30. A brake apparatus using magnetic powder according to claim 17, wherein a cover in which a plurality of air holes are formed is provided out of the second bracket, and wherein a fan for forcibly blowing air is installed at a side of the cover.

31. A brake apparatus using magnetic powder according to claim 18, wherein a cover in which a plurality of air holes are formed is provided out of the second bracket, and wherein a fan for forcibly blowing air is installed at a side of the cover.

32. A brake apparatus using magnetic powder according to claim 19, wherein a cover in which a plurality of air holes are formed is provided out of the second bracket, and wherein a fan for forcibly blowing air is installed at a side of the cover.

33. A brake apparatus using magnetic powder according to claim 20, wherein a cover in which a plurality of air holes are formed is provided out of the second bracket, and wherein a fan for forcibly blowing air is installed at a side of the cover.
